(19) United States
(12) Patent Application Publication
(10) Pub. No.: US 2005/0248933 A1
(43) Pub. Date: Nov. 10, 2005

(54) Light emitting device capable of being combined to a tool

(76) Inventors: Chang Hao Chen, Tao Yuan City (TW); Wu Chun Hsu, Tao Yuan City (TW)

Correspondence Address: Chang Hao Chen, 235 Chung - Ho, Box 8-24, Taipei, TW

(21) Appl. No.: 10/840,043

(22) Filed: May 7, 2004

(51) Int. Cl. B25B 23/18

(52) U.S. Cl. 362/119

(57) ABSTRACT

A light emitting device capable of being combined to a tool comprises a light emitting handle having a receiving hole at one end thereof. A transparent plug made of hard plastics; .the transparent plug having a shape coupled to the receiving hole; the transparent plug installed in the receiving hole of the light emitting handle and having a via hole. A metal plate is in the via hole; one tip end of the metal plate being protruded from one end of the transparent plug so that the light emitting device is as an opener; or an insertable pencil or a refill of a pen is assembled into the via hole of the light emitting handle so that the light emitting handle has the function of writing; or a telescopic tube is installed in the via hole of the transparent plug. The transparent plug can be mixed with fluorescent emitting material.

### FIELD OF THE INVENTION

The present invention relates to light emitting tools, and particularly to a light emitting device capable of being combined to a tool, wherein the light emitting device can be used as an opener, a pencil, a light indicator, etc.

### BACKGROUND OF THE INVENTION

With reference to FIG. 1, a prior art light emitting handle 10 is illustrated. The light emitting handle 10 has a cylindrical body 11, a transparent joint 12, a battery 15, an LED lamp 14. The transparent joint 12 has a light effect by radiation of light emitted from the light emitting handle 10. An end of the transparent joint 12 has an inserting hole 13 for assembling with an opener 20. The opener 20 is a solid iron bar 21. One ends thereof has an inserting head 23 for being inserted into the inserting hole 13 of the transparent joint 12. A tip 22 of the solid iron bar 21 can be used to rotate a screw (not shown).

However the prior art has the following defects. Since the solid iron bar 21 is solid and non-transparent so that light effect only presents in the tip portion. Thereby the illumination is insufficient as the tool is used in a dark place. Thereby the tool has only one function of being used as an opener. The usage is confined.

### SUMMARY OF THE INVENTION

Accordingly, the primary object of the present invention is to provide a light emitting device capable of being combined to a tool, wherein the light emitting device can be used as an opener, a pencil, a light indicator, etc.

To achieve above objects, the present invention provides a light emitting device capable of being combined to a tool which comprises a light emitting handle having a receiving hole at one end thereof. A transparent plug made of hard plastics; .the transparent plug having a shape coupled to the receiving hole; the transparent plug installed in the receiving hole of the light emitting handle and having a via hole. A metal plate is in the via hole; one tip end of the metal plate being protruded from one end of the transparent plug so that the light emitting device is as an opener; or an insertable pencil or a refill of a pen is assembled into the via hole of the light emitting handle so that the light emitting handle has the function of writing; or a telescopic tube is installed in the via hole of the transparent plug. The transparent plug can be mixed with fluorescent emitting material.

The various objects and advantages of the present invention will be more readily understood from the following detailed description when read in conjunction with the appended drawing.

### BRIEF DESCRIPTION OF THE DRAWINGS

FIG. 1 shows a perspective view of a prior art (A) and an assembled view of the prior art (B).

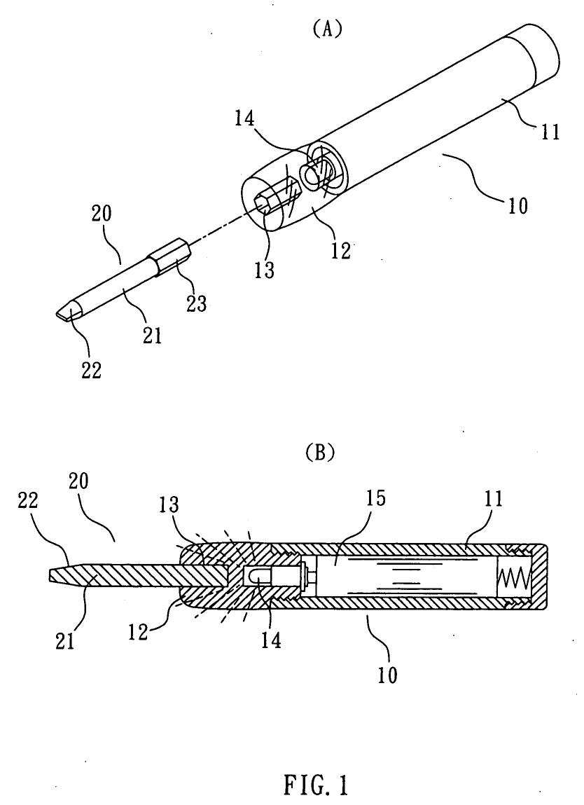

FIG. 2 is an exploded perspective view of the present invention.

FIG. 3 shows the embodiments of the present invention, wherein in (A) a sheet like metal plate is used; in (B), a cruciform metal plate is used, in (C), an insertable pencil is used; and in (D), a refill of a pen is used in the present invention.

FIG. 4 shows one embodiment of the present invention wherein (A) is an exploded perspective view and (B) is an assembled cross sectional view.

FIG. 5 shows another embodiment of the present invention, wherein (A) is an exploded perspective view and (B) is an assembled cross sectional view.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

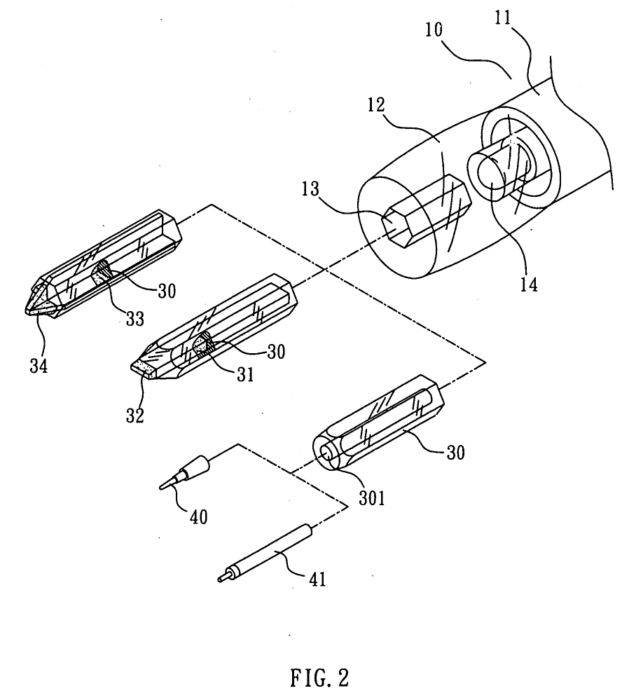

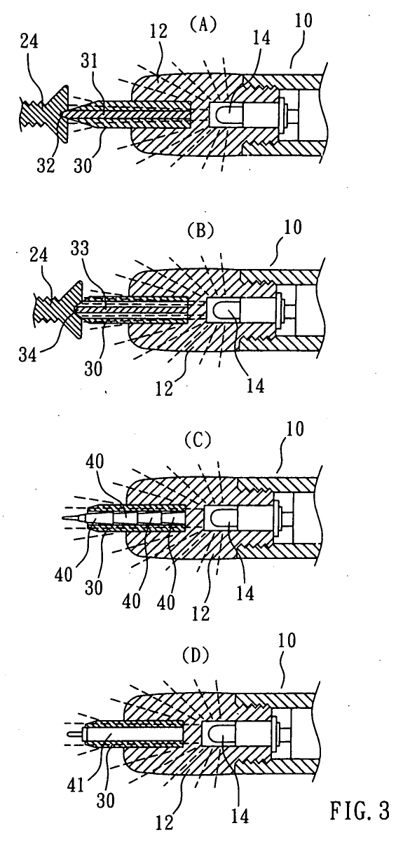

Referring to FIGS. 2, 3A, 3B, 3C and 3D, a light emitting device capable of being combined to a tool of the present invention is illustrated. The device comprise the following elements.

A light emitting handle 10 has a receiving hole 13 at one end thereof.

A transparent plug 30 is installed in the receiving hole 13 and is made of hard plastics. The transparent plug 30 has a shape coupled to the receiving hole 13 of the light emitting handle 10. There may be a plurality of different kinds of transparent plugs 30. The transparent plug 30 can have a via hole 301 for inserting an object, such as an insertable pencil 40, a refill of a ball pen 41 for writing.

A metal plate 31 (or 33) is enclosed by the transparent plug 30. One tip end 32, 34 of the metal plate is protruded from one end of the transparent plug 30. The tip end can be used as an opener head.

With reference to FIG. 3, it is illustrated that the light emitting handle 10 has an LED lamp 14 is within the light emitting handle 10. The transparent plug 30 is inserted into the receiving hole 13. In this embodiment, the metal plate 31 is a thin sheet. The tip 32 is protruded from one end of the transparent plug 30. Since the light emitting handle 10 can emit light, the light transmits through the plastic transparent plug 30 so that the transparent plug 30 has a light effect and the light will radiate the tip end 32. The tip end 32 is used to screw a screw 24. Thereby the user can operate easily and convenient.

In FIG. 3B, the metal plate 33 has a cruciform so as to form as a cruciform opener.

In FIG. 3C, it is illustrated that an insertable pencil 40 is assembled into the via hole 301 of the light emitting handle 10 so that the light emitting handle 10 has the function of writing. The light transmits through the transparent plug 30 so as to radiate the insertable pencil 40. In FIG. 3D, a refill 41 is assembled into the via hole 301.

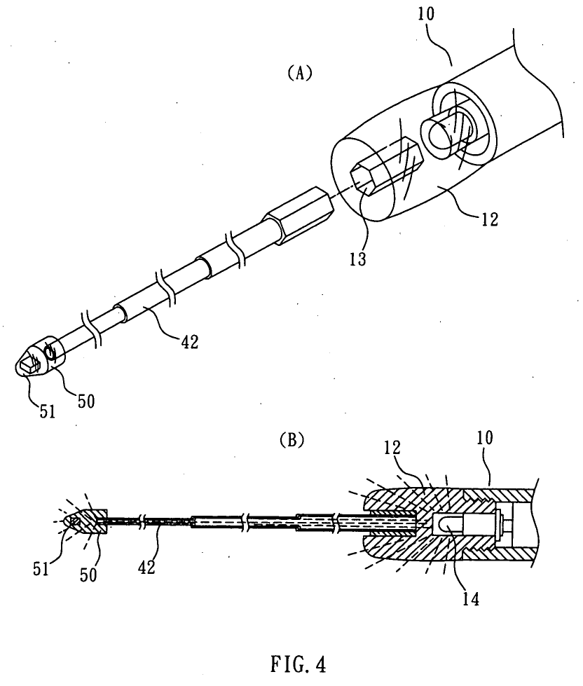

In FIGS. 4A and 4B, a telescopic tube 42 has a transparent end 50 and a magnet 51 is installed at one the transparent end 50. The magnet 51 serves to attract objects, such as screws, nails, nuts, etc. Light emitting from the light emitting handle 10 will light up the magnet so that as in dark, the operator can operate the tool conveniently. For example, in case that the user desires to pick up an object in a dark place.

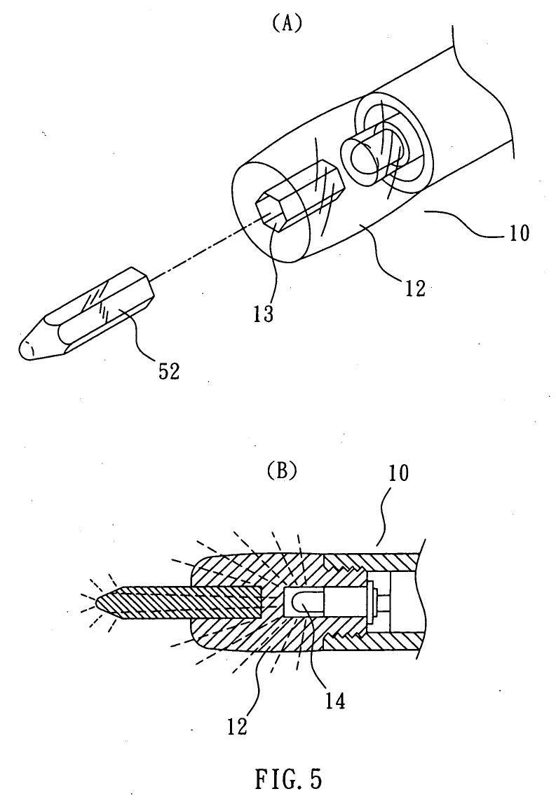

In FIGS. 5A and 5B, the transparent plug 30 has a solid structure so that the light emitted from the light emitting handle 10 passes through the transparent plug 30 to be as a light pen to radiate an object. Thus the user can view the object clearly

Moreover, in the present invention, a laser lamp can be installed within the light emitting handle 10 so as to be as a light source of the light emitting handle 10. Moreover, in the present invention, the transparent plug 30 can be mixed with fluorescent emitting source so that the transparent plug 30 has fluorescent effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A light emitting device capable of being combined to a tool comprising;
a light emitting handle having a receiving hole at one end thereof.
a transparent plug installed in the receiving hole and made of hard plastics; .the transparent plug having a shape coupled to the receiving hole of the light emitting handle; the transparent plug having a via hole;
a metal plate in the via hole of the transparent plug; one tip end of the metal plate being protruded from one end of the transparent plug so that the light emitting device is used as an opener.

2. The light emitting device capable of being combined to a tool as claimed in claim 1, wherein an LED lamp is installed within the light emitting handle as a light source.

3. The light emitting device capable of being combined to a tool as claimed in claim 1, wherein a laser light source is installed within the light emitting handle as a light source.

4. The light emitting device capable of being combined to a tool as claimed in claim 1, wherein the metal plate is a thin sheet; the tip end for the metal plate is protruded from the end of the transparent plug so that the light emitting device is used as an opener.

5. The light emitting device capable of being combined to a tool as claimed in claim 1, wherein the metal plate is a cruciform metal plate; the tip end of the metal plate is protruded from the end of the transparent plug so that the light emitting device is used as an opener with a cruciform end.

6. The light emitting device capable of being combined to a tool as claimed in claim 1, wherein the transparent plug is mixed with fluorescent emitting source so that the transparent plug has fluorescent effect.

7. A light emitting device capable of being combined to a tool comprising;
a light emitting handle having a receiving hole at one end thereof.
a transparent plug installed in the receiving hole and made of hard plastics; .the transparent plug having a shape coupled to the receiving hole of the light emitting handle; the transparent plug having a via hole.

8. The light emitting device capable of being combined to a tool as claimed in claim 7, further comprising:
an insertable pencil assembled into the via hole of the transparent plug so that the light emitting handle has the function of writing.

9. The light emitting device capable of being combined to a tool as claimed in claim 7, further comprising
a refill of a pen assembled into the via hole of the transparent plug so that the light emitting handle has the function of writing.

10. The light emitting device capable of being combined to a tool as claimed in claim 7, further comprising:
a telescopic tube installed in the via hole of the transparent plug.

11. The light emitting device capable of being combined to a tool as claimed in claim 10, wherein a magnet is installed at a front end of the telescopic tube.

12. The light emitting device capable of being combined to a tool as claimed in claim 7, wherein the via hole is filled with material same as the material of the transparent plug.

13. The light emitting device capable of being combined to a tool as claimed in claim 7, wherein the transparent plug is mixed with fluorescent emitting source so that the transparent plug has fluorescent effect.
